(19) United States
(12) Patent Application Publication
(10) Pub. No.: US 2018/0283406 A1
(43) Pub. Date: Oct. 4, 2018

(54) METHOD AND DEVICE FOR PUMPING A PRODUCT BY SUCTION

(71) Applicant: ORTEC EXPANSION, Aix-en-Provence (FR)

(72) Inventor: Daniel Rivard, Paris (FR)

(73) Assignee: ORTEC EXPANSION, Aix-en-Provence (FR)

(21) Appl. No.: 15/765,945

(22) PCT Filed: Oct. 5, 2016
(86) PCT No.: PCT/FR2016/052551

§ 371 Date: Apr. 4, 2018

(30) Foreign Application Priority Data
Oct. 8, 2015 (FR) 1559578

(51) Int. Cl. F04F 1/02; F04F 1/14; F04F 1/10; F04C 19/00; B01D 21/26

(52) U.S. Cl. CPC F04F 1/02; F04F 1/14; B08B 9/0933; F04C 19/001; B01D 21/267; F04F 1/10

(57) ABSTRACT

According to the present invention: the product (10) is sucked into a first transit vessel (2) placed under vacuum and, simultaneously, a second transit vessel (3) is emptied by flushing under pressure; and then, said product is sucked into said second transit vessel (3) placed under vacuum and, simultaneously, said first transit vessel (2) is emptied by flushing under pressure.

The present invention relates to a method and a device for the pumping of a product by vacuum suction. Although not exclusively, it is particularly appropriate to be implemented for the pumping of products susceptible to producing an explosive atmosphere and/or producing volatile organic compounds.

It is known that numerous industries, for example chemical, petrochemical, food-processing, metallurgic, etc., produce sludge that is susceptible to producing an explosive atmosphere and/or producing volatile organic compounds. This sludge is generally stored in tanks, from which it must be pumped to be transported to specialist treatment and/or storage sites.

Such pumping operations are equally necessary for flushing industrial sewers, for recovering waste produced by the high-pressure cleaning of industrial facilities, for extracting sludge from waste water treatment plants, for draining the bases of tanks so as to permit their inspection or their maintenance, etc.

These pumping operations present numerous risks, to the health and safety of operators and residents, as well as to the protection of facilities and of the environment, which are linked to the explosive nature of the pumped products and the emission of harmful gases like the volatile organic compounds.

In order to carry out such pumping operations, a vacuum pump can be used to empty the tank containing the products to be pumped. A storage chamber is arranged between the vacuum pump and a suction pipe which is permanently immersed in the product to be vacuum pumped.

This technique has the advantage of allowing a function stoppage of the vacuum pump during the pumping operation, while maintaining a suction capacity as long as the differential with regards to the atmospheric pressure exists. It thus allows the tank to be completely drained. In addition, it ensures the draining of the pumping circuit. Moreover, it allows the pump to be installed at long distances from the product to be pumped due to the force of the suction. It also allows for the avoidance of the pump coming into contact with the product with the exception of vapours or gases, and for the quantity of rejected pollutants to be limited, and for the danger zone to be restricted to the pumping zone.

On the other hand, the main drawback of such a suction pumping technique is the furthering of the desorption of volatile products and thus the emission of explosive gases and of volatile organic compounds.

The object of the present invention is to perfect the technique of pumping by vacuum suction, in order to conserve the advantages and eliminate the drawbacks.

To that end, according to the invention, the method for the pumping of a product by vacuum suction is remarkable in that, in an alternating fashion:
it sucks up the product into an initial transit tank under vacuum and, simultaneously, it empties a secondary transit tank by flushing it under pressure,
then, it sucks up said product into said secondary transit tank under vacuum and, simultaneously, it empties said initial transit tank by flushing it under pressure.

In this way, in the method true to the present invention, the two transit tanks work simultaneously and alternately, one being filled with the product by vacuum suction and the other being emptied under pressure of the previously suctioned product. Each transit tank is thus alternately filled with product, then emptied of it.

Although the vacuum suction and the flushing under pressure of said transit tanks can be done by any desired method, it is advantageous that, for the vacuum suction of said initial and secondary transit tanks, the suction vacuum of a vacuum pump, rather than a water-ring vacuum pump is used, and that, for the flushing under pressure of said initial and secondary transit tanks, the expulsion pressure of said vacuum pump is used. The invention also makes use of the fact that the use of repressed gases by the vacuum pump as a source of pressure does not modify the capacity of said pump to produce the vacuum.

Very frequently, industrial pumping products contain solid foreign bodies and must therefore be filtered at the time of pumping. Yet, such filtration is highly disadvantageous in regards to the flow of pumping. To avoid such a drawback, in accordance with another particularity of the present invention, said initial and secondary transit tanks are used to eliminate foreign bodies present in said product to be pumped. To do this, said transit tanks can be cyclonic tanks.

The present invention also relates to a device for the pumping of a product by vacuum suction, said device comprising a vacuum source and a suction nozzle of said product and is remarkable in that it comprises:
a pressure source,
two transit tanks for said product, and
a set of controlled valves connecting, simultaneously and alternately, one of said transit tanks to said vacuum source and to said suction nozzle and the other of said transit tanks to said pressure source and to a reception tank of said product.

As mentioned above, the vacuum suction and the pressurisation of said transit tanks can be obtained by a vacuum pump, preferably a water-ring vacuum pump. In this case, said vacuum source and said pressure source are respectively made up of the suction opening and by the expulsion opening of said vacuum pump.

Such a pumping device allows the pumping of products of which the flashpoint is lower than 60° C.

As previously indicated, in this pumping device in accordance with the present invention, said transit tanks can be cyclonic tanks allowing the elimination of solid foreign bodies contained in the product to be pumped.

It will be noted that said vacuum and pressure sources (the vacuum pump), said suction nozzle, said transit tanks and said set of controlled valves form a vacuum pumping unit which, for security reasons, must preferably be moved away from the product reception tank which, is under the atmospheric pressure or under a slightly higher pressure. To that end, the pumping device in accordance with the present invention is connected to said reception tank by a long pipe allowing said vacuum pumping unit to be moved away from said product reception tank.

The length of such a linking pipe can be in the range of several tens of metres, for example at least 50 metres.

In order to be able to empty different geographically distributed industrial sites of their products susceptible to producing explosives atmospheres and/or volatile organic compounds, it is advantageous that the pumping device in accordance with the present invention is moveable, for example is transported by a motor vehicle.

The figures of the appended drawing will lead to the understanding of how the invention can be implemented, in these figures, identical references indicate identical elements.

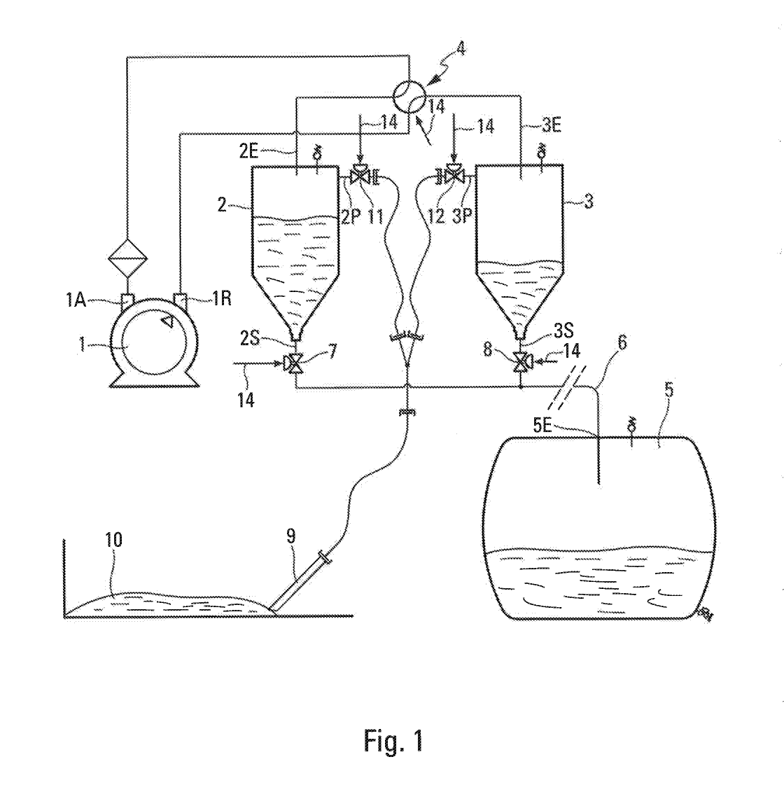

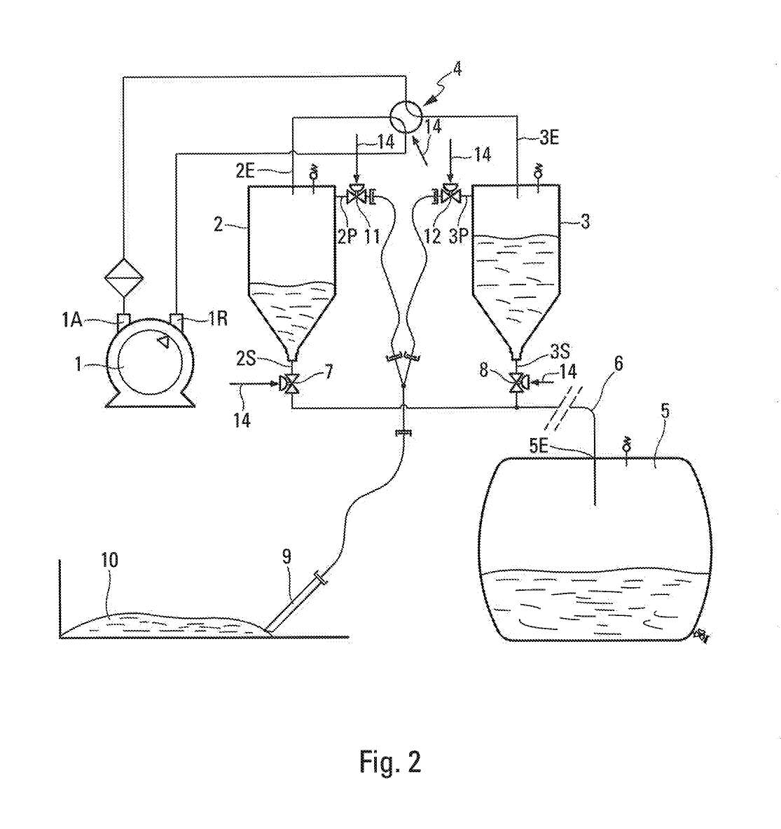

FIGS. 1 and 2 illustrate an exemplary embodiment of the pumping device in accordance with the present invention in two different alternating operating phases.

The embodiment of the device in accordance with the present invention represented schematically in FIGS. 1 and 2 comprises:
a vacuum pump 1, for example a water-ring pump, comprising a suction opening 1A and an expulsion opening 1R;
an initial transit tank 2, preferably a cyclonic tank, comprising a fluidic inlet 2E, a product inlet 2P and a product outlet 2S;
a secondary transit tank 3, preferably a cyclonic tank, comprising a fluidic inlet 3E, a product inlet 3P and a product outlet 3S;
a four-way valve 4, placed between the suction opening 1A and the expulsion opening 1R of the vacuum pump 1, on the one hand, and the fluidic inlets 2E and 3E of the initial and secondary transit tanks 2 and 3 on the other hand;
a product reception tank 5, comprising a product inlet 5E;
controlled drain valves 7 and 8 respectively connecting outlets 2S and 3S of the transit tanks 2 and 3 to the product inlet 5E of the reception tank 5 by way of a long pipe 6, of a length of at least equal to 50 metres;
a suction nozzle 9 of a product 10 to be pumped, respectively connected to the product inlets 2P and 3P of the initial and secondary transit tanks 2 and 3, by controlled filling valves 11 and 12; and
a control system 14 (only represented in FIGS. 1 and 2 by arrows) to con he valves 4, 7, 8, 11 and 12.

In an initial operation phase of the device of the invention, represented in FIG. 1 and controlled by the control system 14, the four-way valve 4 links the fluidic inlet 2E of the transit tank 2 to the suction opening 1A of the vacuum pump 1 and the fluidic inlet 3E of the transit tank 3 to the expulsion opening 1R of said pump. In addition:
the drain valve 7, at the outlet 2S of the transit tank 2, is closed;
the filling valve 11, at the product inlet 2P of the transit tank 2, is open;
the filling valve 12, at the product inlet 3P of the transit tank 3, is closed; and
the drain valve 8, at the outlet 35 of the transit tank 3, is open.

In these conditions, the transit tank 2 is put under vacuum by the pump 1 and the product 10, potentially accompanied by air, is sucked into said tank 2 by means of the suction nozzle 9, the filling valve 11 and the product inlet 2P. The suctioned product is retained in the transit tank 2, then the drain valve 7 is closed. Simultaneously, the transit tank 3 is put under pressure by the expulsion opening 1R of the pump 1 and the product previously sucked into said transit tank 3 is flushed into the reception tank 5 by means of the outlet 35, the drain valve 8 and the long pipe 6.

In reverse, in a second operation phase of the device of the invention represented in FIG. 2, and also controlled by the control system 14, the four-way valve 4 connects the fluidic inlet 3F of the transit tank 3 to the suction opening 1A of the vacuum pump 1 and the fluidic inlet 3E of the transit tank 2 to the expulsion opening 1R of said pump. In addition:
the drain valve 8, at the outlet 3S of the transit tank 3, is closed;
the filling valve 12, at the product inlet 3P of the transit tank 3, is open;
the filling valve 11, at the product inlet 2P of the transit tank 2, is closed; and
the drain valve 7, at the outlet 2S of the transit tank 2, is open.

In these conditions, the transit tank 3 is put under vacuum by the pump 1 and the product 10, potentially accompanied by air, is sucked into said tank 3 by means of the suction nozzle 9, the filling valve 12 and the product inlet 3P. The suctioned product is retained in the container 3, then the drain valve 8 is closed. Simultaneously, the transit tank 2 is put under pressure by the expulsion opening 1R of the pump 1 and the product previously sucked into said transit tank 2 is flushed into the reception tank 5 by means of the outlet 2S, the drain valve 7 and the long pipe 6.

The alternation of said first and second phases controlled by the control system 14 thus allows the product 10 to be pumped by the suction nozzle 9 to transport it into the reception tank 5, implementing not only the suction vacuum produced by the pump 1 at its suction opening 1A, but also the pressure produced by said pump 1 at its expulsion opening 1R.

Although it is not represented in FIGS. 1 and 2, it will be understood easily:
that the pumping device described above, consisting of the vacuum pump 1, the transit tanks 2 and 3, the valves 4, 7, 8, 11 and 12 and the control system 14, can be transported by a motor vehicle or a trailer to be moveable and to be able to be moved and to pump products 10 into different places;
that, also, the pumped product reception tank 5 can be moveable; and
that the pipe 6 can be provided to be mounted in a removable way, from one side to the pumping device and, from the other side, to the pumped product reception tank 5.

In addition, the pumping device has numerous advantages and additional characteristics, and notably:
it enables the amount of time taken to put the liquid under vacuum to be limited;
it allows the liquid and exhaust emissions to be flushed from the same vacuum pump while continuing the pumping;
the reception tank is not a container under vacuum, but a simple storage container;
it can lead to short cycle times with reduced volumes under reduced vacuum; and
the pumping of the product is alternated between the tanks, but it is done continuously.

Further, with the treatment on both phases (liquid/gas) by restricted quantities contained alternately in the transit tanks, tanks which are arranged in parallel in the operating circuit, the alternation of the flushing cycles between the two parallel tanks allows the product to be contained and expulsed in its entirety (gaseous phase included) into the storage tank, in steps. The phenomenon of desorption is reduced and treated by the alternating phasing of vacuum-compression sequences, on increasingly lower volumes being put under vacuum during short exposure times.

In addition, the ratio between the capacity of the transit tanks and that of the reception tank is, preferably, in the order of 1/10.

1. A method for pumping a product by vacuum suction, the method comprising:
sucking product into an initial transit tank under vacuum and, simultaneously, emptying a secondary transit tank by flushing under pressure product previously suctioned into a reception tank; and thereafter
sucking product into said secondary transit tank under vacuum and, simultaneously, emptying said initial transit tank by flushing under pressure product previously suctioned into the reception tank.

2. The method of claim 1, wherein, for the placing under vacuum of said initial and secondary transit tanks, the suction vacuum of a vacuum pump is used, and wherein, for the flushing under pressure of said initial and secondary transit tanks, the expulsion pressure of said vacuum pump is used.

3. The method of claim 1, wherein said initial and secondary transit tanks are used to eliminate solid foreign bodies present in said product.

4. A device for pumping a product by vacuum suction, comprising:
a vacuum source;
a suction nozzle;
a pressure source;
two transit tanks for product;
a set of controlled valves connecting, simultaneously and alternately, one of said transit tanks to said vacuum source and to said suction nozzle, and the other of said transit tanks to said pressure source and a reception tank.

5. The pumping device of claim 4, further comprising a vacuum pump, wherein said vacuum source and said pressure source are respectively made up of the suction opening and the expulsion opening of said vacuum pump.

6. The pumping device of claim 5, wherein said vacuum pump is of water-ring type.

7. The pumping device of claim 4, wherein said transit tanks are cyclonic tanks.

8. The pumping device of claim 4, wherein the pumping device is linked to said reception tank by a pipe which allows said pumping device to be moved away from said reception tank.

9. The pumping device of claim 8, wherein the length of the pumping device is at least 50 meters.

10. The pumping device of claim 8, wherein the pumping device is moveable.
